(19) United States
(12) Patent Application Publication
(10) Pub. No.: US 2012/0084189 A1
(43) Pub. Date: Apr. 5, 2012

(54) METHOD FOR COSTING, FINANCING AND MANAGING PERPETUAL DIGITAL STORAGE AND ACCESS (ARCHIVING)

(76) Inventors: Peter Nelson Schmitt, Snoqualmie, WA (US); Craig Dominic Mahany, Kirkland, WA (US)

(21) Appl. No.: 13/204,001

(22) Filed: Aug. 5, 2011

Related U.S. Application Data
(60) Provisional application No. 61/371,511, filed on Aug. 6, 2010.

(51) Int. Cl. G06Q 40/00

(52) U.S. Cl. 705/35

(57) ABSTRACT

A technical and commercial method of managing information is provided including the investment of company funds in a trust/foundation and or utilization of a Financial Instrument associated with the long term or perpetual Storage and Access of the information or intellectual property (IP). The Financial Instrument provider or trust/foundation manager is the Custodian of the instrument/trust/foundation and responsible for assuring the fees are paid to the designated Trustee for the perpetual or long term maintenance of the Digital Information in a safe repository accessible via various modern operating systems and hardware. Further, the Financial Instrument/Trust/Foundation can be managed separately from the Trustee to further ensure its enduring integrity and long term viability, though the fees are applicable to continued access to the Digital Content in the safe repository through an electronic communications network.

### PRIORITY CLAIM

This application claims priority to U.S. Provisional Patent Application Ser. No. 61/371,511 filed Aug. 6, 2010, which application is incorporated by reference in its entirety as if fully set forth herein.

### COPYRIGHT NOTICE

This disclosure is protected under United States and International Copyright Laws. © 2010-2011 Peter Schmitt and Craig Mahany. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention relates generally to a technical and commercial method of providing long term/Perpetual content hosting and management services in a safe online repository including differentiated payment methods that ensure adequate funding for the continued Safe, Storage, Access and Management of private or publicly available digital content or intellectual property (IP), for an agreed term. Utilizing professional analysis of past and present storage, access, CPU and application fees (including but not limited to those of IAAS, PAAS and SAAS vendors), as well as current and predicated technology innovations and using this information to determine a cost basis for the perpetual storage, access, CPU and application fees, needed to allow a business to determine the size of a one-time fee (or an associated installment plan option for that fee) that would need to be charged to ensure the long term or perpetual storage, access and maintenance of content in a safe repository. The Custodian can be defined as a Financial Instrument provider, a person or entity responsible for a long term or perpetual trust/foundation or simply the payment recipient responsible for assuring fees are paid to the designated data conservator also referred to herein as the Trustee or service provider for the maintenance of the Storage and Access of Digital Information in a safe repository for the term and under the conditions agreed with the founder including the ability to ensure content remains available in a format easily viewable buy common operating systems and hardware platforms popular over time. Further, the Custodian role (which may include one or more unique methods of funding a safe repository (i.e. one-time-payment, installment payment, annuity, perpetuity, trust, foundation, Grants . . . )) can be) separate from the Trustee/service provider role to help ensure its enduring integrity and long term viability, though the fees are applicable to ensuring continued access to the Digital Content in the safe repository through an electronic communications network. Storage, Access and maintenance of the Digital Content is provided by a Trustee who's role it is to ensure that all of the content in the safe repository is maintained according to the policies agreed with and established by the original purchaser (Founder) of the safe repository and or the Custodian including the assignment of management and submission rights and regulations to a Curator upon his or her demise or incapacity and the Curator's rights to re-assign his rights upon his demise or incapacity. Founder and or Curators may elect to increase the size or access quality of the safe repository however the Polices for management of safe repository and or the content contributed by the original purchaser of the financial instrument preferably cannot be altered by a Curator. Curators have the responsibility to ensure some or all content contributed to the safe repository is in line with the Polices defined by the original purchaser of the financial instrument (weather via a security or direct purchase) and, where not conflicting, the policies of the contributor as well. Where policy allows, users granted appropriate permissions can access and amend a value-added access file, files or other information associated with, yet separate from, the content

### BACKGROUND OF THE INVENTION

Many web services (i.e., Costco®, Snapfish™, Shutterfly™, Smilebox™, YouTube™, Carbonite™, flickr®, Facebook® and the like), as well as those focused on film processing, print-based story books, photo and video storage sites, digital slide generation, applications and services, cloud-based storage and backup services, social networking and ubiquitous digital devices are focused on the storage and access of photographs and video but do not address the requirements for the indefinite and perpetual storage, access and maintenance of content in a safe repository nor even long term archival concerns which would be required to ensure that all future generations have the access to the content intended and required to leave a rich digital legacy.

What is available today falls short in the following ways: Most services Retention Policies put your data at risk. Existing services do not guarantee availability of your content beyond a monthly or yearly (payment, purchase). Most Services do not allow multiple people to contribute content to or share an active archive no less control the capability of that access indefinitely. Most Social Networking Services only support low res versions of your content which has limited preservation value and as we have seen with service providers like My Space often do not have business models to support long term or perpetual access to your content. Most back up services do not format content (documents, moving and still pictures . . . ) specifically for the viewer's hardware no less render that content for online viewing. Photo Services focus on print books scenarios which deteriorate and get lost over time or specialty.

Other Service types available today falls short in the following ways: The ability to share key content with those who use different services is limited; the ability to cross search/access/tag . . . key content between services doesn't really exist; Websites like You Tube™ are geared to one off video snippets or a photo of high entertainment value to the public not private sentimental value and have a very limited number of minutes (YouTube™) in recording length; Leading Services do not allow you to richly embellish your content (with voice for instance); Scrapbook applications are too complicated and time consuming for most users and other software is only geared toward slide show generation, leaving a big gap in the middle. Many Social Networks do not support basic slide show functionality no less provide services that enable rich digital story telling.

### BRIEF DESCRIPTION OF THE DRAWING

Embodiments of the present invention are described in detail below with reference to the following drawing.

FIG. 1 is a system hardware and software overview of the embodiments of the present invention and high level overview of some of its key processes. As documented in FIG. 1, providing an online archive that can house digital or digitized content that, for example, an individual or family may have available today, and want to ensure not only that this content will be available and adapted to ensure it is viewable online by all forward generations in perpetuity but that it can grow over time as a family grows and that related but separate family archives can be linked in; requires the integration of traditional IT systems with a plethora of some specific high availability technology's (i.e. Database Engines, Search Engines, Rendering Engines, E-Mail Services, Transcoding Engines, API's, workflow engines, application and internet servers, Operating Systems, Directory Services, Redundant and geographically dispersed online storage vendors, offline storage facilities, network access providers, CPU service providers) coupled with LAC's unique payment options including its onetime payment option (or installments of the single one-time payment option), it's unique processes (i.e. the investment of all or a portion of the fees collected into a trust to ensure adequate monies are available to fund the perpetual nature of the archive), it's one of kind concierge quality support for the digital preservation of personal family history and content and its industry leading warranties/guarantees.

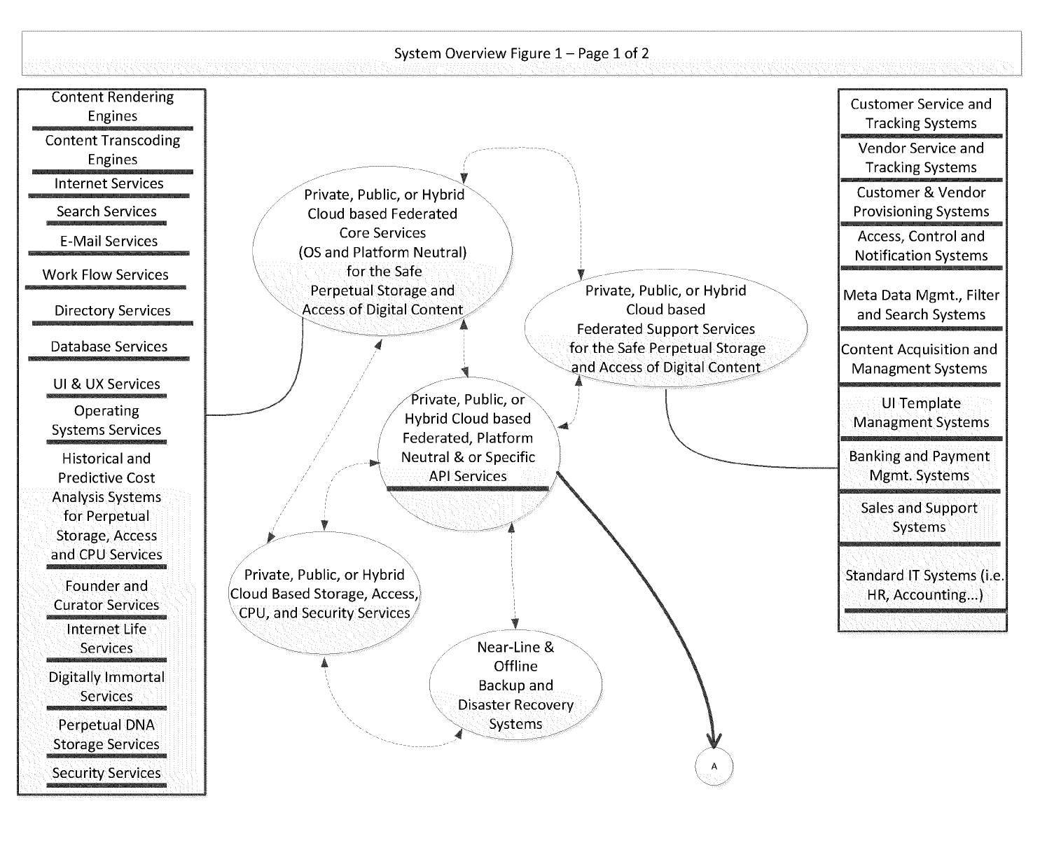

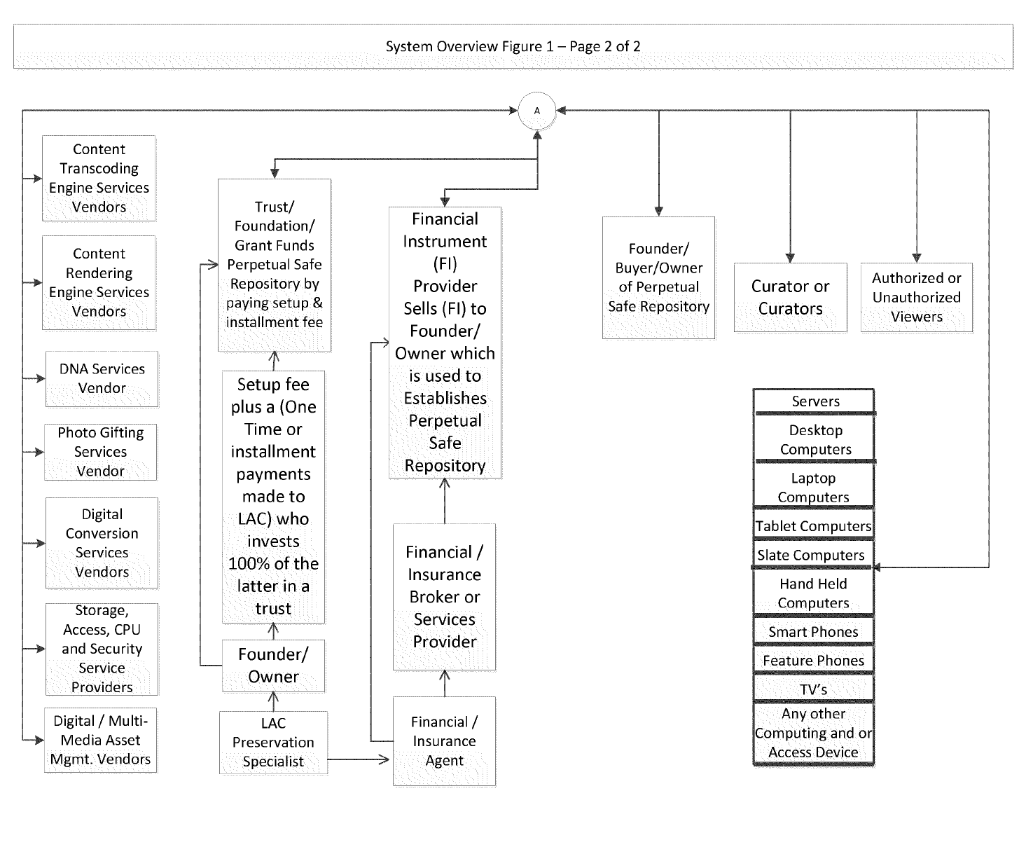

### DETAILED DESCRIPTION OF THE PREFERRED EMBODIMENTS

Our most meaningful still and moving pictures, documents, and sound files are subject to deterioration and often some specialized equipment (that is or near end of life) can be required to view or convert old content. Hard disk crashes, and deterioration of digital and traditional media, including memory chips, negatives, compact discs and the like; digital media storage website disappearance; and/or digital media storage website retention policies can cause unwanted deletion, not to mention perpetual monthly storage fees and the like. One embodiment of the present invention includes a digital archive that can be trusted to house and make available (on the founders terms, for the desired duration) an individual or family's most precious and personal digital or digitized content, optionally funded by one of our unique payment options (i.e. one-time payment, Installment version of “one-time payment”, annuity, perpetuity, trust, foundation . . . ), to ensure access is guaranteed for future generations by our trustee function designed to ensure the user-specified data and access policies can be carried out forever or for the term agreed so future generations receive the intended benefit.

In one embodiment of the invention, an example of how the system works would go something like this: an Agent sells a Financial Instrument (i.e. Annuity) to cover content hosting and receives x % commission on the sale and X % recurring revenue for an agreed term; the agent might pass the agreement through a licensed Broker who takes a X % commission; the Broker passes agreement to the Financial Instrument Provider who may take X % Commission and profit from the difference between what they earn on the money versus what they have to pay the trustee; the Financial instrument Provider Utilizes Legendary Archives Company as the Trustee and Services fulfillment entity and sends data for service establishment plus a X % one-time setup fee plus a X % per year maintenance fee paid monthly/quarterly in advance. Legendary Archives Company provisions the owner per the provided instructions and notifies him/her of their access information. The Founder or his/her delegate or delegates, populates the system with content and sets the access policies. Should they utilize a digital conversion partner of Legendary Archives Company the digitally converted data may be loaded into the archive for them.

In another embodiment of the invention, Legendary Archives Company representatives or its sales affiliates sell an archive and takes a one-time sales fee (which Legendary Archives Company invests in a safe and secure trust) based on the desired size, term and conditions related to the archive and for the sole purpose of maintaining that archive in perpetuity, the sales person may get a one-time commission and possibly recurring revenue for a term as well. In addition, Trustee may collect fees for other related services (Scanning digital content, Create Print Books, Calendars and the like). Cost reduction in Storage and Transmission costs per GB are expected to decrease over time which should allow Legendary Archives Company to offer its planned periodic enhancement to the size and access terms of the archive over time.

By way of a provisioning system which can allow simple electronic interaction with financial instrument providers we can provide cost effective fulfillment and tracking and ensure accurate fulfillment of services.

Independence from and/or management of storage, access and CPU service providers as well as content converters, can help ensure customers and their ancestors get the service level they paid for in perpetuity (or for the agreed term). This embodiment of the invention can provide a user interface to easily upload and manage digital content as well as for agents to track the status of fulfillment.

Each embodiment of the invention ensures a founder's most cherished memories and content can be perpetually stored online and accessed and or embellished by Founder/Curator-defined friends and family for all forward generations. Founders/Curators may elect to allow others to contribute content creating a Digital Family Archive that can grow in value to each future generation regardless of which Legendary Archive financial instrument is used or payment option selected.

One embodiment of the invention may automatically generate a version of your archive that can be viewed on anything from a cell phone to a PC to a Large Screen TV via Legendary Archives Company web services.

One embodiment of the invention provides for a digital concierge service that provides consulting service starting with preservation and organization of a safe repository's authorized user's documents, prints, tapes and film, as well as the digital conversion of content and then the perpetual or term based high availability storage, access and management of that content.

One embodiment of the invention includes an insurance offering allowing families to buy a policy that protects the perpetual storage, access and management of their safe repository of their most cherished digital memories.

One embodiment of the invention includes the purchase of an insurance-based annuity to fund the perpetual storage, access and management of their most cherished digital memories in a safe repository.

The invention allows a user to easily pull content from or share content via Social Networking sites (such as Facebook, Google+, flickr, and the like) where the user's friends and/or family have given the user access. Since this archive would contain the original files in their original resolution it is well suited to feed these others services as they increase the resolution of what they store.

Memory Resident Applications (such as on iPhone/iPAD, Android Phones/PAD's, and Windows) can allow a customer to easily and optimally (through tight integration) capture and contribute to their archive and or view content from it.

The invention can allow a user to easily publish their content to web services with appropriate API's.

One embodiment of the invention includes a basic player which allows a user to peruse their content in a familiar and discoverable way.

In another embodiment of the invention, a user may Edit/Layout, view, share their content in high value stories using a proprietary Layout Editor provided by Legendary Archives Company, that provides a unique solution for creating rich digital stories. The player allows a user to consume the specially laid out content in a familiar and discoverable way.

Cross Platform Service Functions allows other websites to utilize the infrastructure of the invention and content optimally on a fee-usage basis. One embodiment of the invention provides ad-funded code (which other services can embed) to allow other services to search permissible content.

Another embodiment of the invention provides aggregate content access and distribution with 3rd Party Services so the user may peruse their content in a more fun and discoverable way.

In yet another embodiment of the invention, a web-based application (though this application may use other forms of code, not limited to web-based code) allows a user access to all of their local content as well as that stored on 3rd party services.

In another embodiment of the invention, a user may pull content from any subscriber-based service that provides an API (Application Programming Interface) and terms of condition that allow its use, into the customers archive.

Another embodiment of the invention includes utilization of embellished content in the creation and preservation of Digital Memories and Stories. One example of this might be the attachment of digital audio to another piece of content. After a user collects their high value content from all of their family members, service providers, devices, storage areas and conversion services into the Legendary Archives Company's service, a user may want to share and/or publish this content through the various services the user's friends and family use.

One embodiment of the invention allows a user to publish independent Content items or content combined into rich Stories to any Service they subscribe too and that provides API's and terms of condition that allow the publishing of such content. The invention can allow for, but is not limited to, integration of such Social Networking Features (i.e., “Like” . . . ), integration with Social Networking Authorization Systems (one option would be to do Co-Login via a common authentication API (i.e. OAuth), which utilize and open or privately available protocol that allows users to share their private content (e.g. photos, videos, audio, documents, contact lists . . . ) stored on one site with different site without having to hand out their username and password) and the like.

Another embodiment of the invention provides search and filter services utilizing existing (internal or external) or user supplied meta data to focus on relevant content and allow those services to be embedded in third party sites serving our custom (potentially ad revenue generating) code.

In yet another embodiment of the invention, a user is provided with secure access services to our content (where permission allows) from a third party web site, on a revenue share basis, (via private pipes) so the hosting fees are shared among services providers.

One embodiment of the present invention includes a web service for digital storytelling. This application and/or service allows a user to create, edit and layout their content, in a digital format that is visually pleasing which can either be auto played or presented in a way that allow users to explore the content, page by page at their own pace, and includes features like zoom in and out of individual content items, hearing audio items associated with a content item, replay an item, and the like.

In yet another embodiment of the invention, the application can allow for digital Scrapbook creation, which would optimally feature multiple content pieces per page, Support 4 or more layers, one for photos, one for frames & mattes, one for stickers and one for complex overlays such as other images including ones containing scrapbook like embellishments.

In another embodiment of the invention, a user is able to embellish content from services with new Meta Data, Voice and Text annotation via our easy to use tools. Users can also have an associated “Group Bucket” that other authorized users can utilize to contribute content or embellishment, thus allowing groups of family and friends to combine efforts to create rich family stories.

In one embodiment of the invention, offerings of packs of page borders, fonts, backgrounds, overlays, shapes, designs and transitions can be available for upgrade. Accounts can have various levels of complexity, including a Low Res, limited Storage version, supported by Ads/Affiliate revenue and template sales; another version might include the ability to create removable media (i.e. DVD's . . . ), locally or through our service offering, full resolution images, various levels of storage, all supported by Service Fees which can be billed singularly, monthly, quarterly or yearly or customized in various attractive rate packages to meet a user's specific storage and budget needs.

One embodiment of the present invention includes group commenting features that enable users to tell stories and share memories about the content item. Commenting features are fully-customizable and may be shared and/or linked to other web services.

One embodiment of the present invention includes Screen-based Digital Story Telling, which, at its core is the organized assembly and enhancement of Text, Audio, Video and Photographic content laid out by the customer in a format that tells a rich and powerful story that is worth sharing and preserving so that it is discoverable for future generations.

Another embodiment of the invention includes offering users fee-based access to treasured content (all access would be controlled with a user's specific privacy controls and the possibility to delegate some or all of those controls in the event the customer is no longer able to do so) for the term the customer desires via the unique payment methods (i.e. one-time-payment, Installment payment, annuity, perpetuity, trust, foundation . . . ) and optionally allowing other services fee based access.

One embodiment of the invention provides Search and Filter Services allowing a user to use Meta data to focus on relevant content and allow those services to be embedded in third party sites serving via our custom code with ad revenue going to Legendary Archives.

In another embodiment of the invention, secure access to our content for third parties on a revenue share basis via private pipes to optionally share the hosting fees among services providers.

One embodiment of the invention includes the establishment and execution of a digital concierge service where by the representatives provide the end to end service a customer requires to get their most cherished content (i.e. Documents, Art, Photo's, Film, Video . . . ) preserved (to the extent feasible by budget), digitally converted and securely stored and perpetually available using a commonly available format of the time. These digital concierge representatives are uniquely compensated with a fixed commission and a recurring (for an agreed term) revenue stream from the yield of the financial instrument or payment invested by Legendary Archives in a trust/foundation.

One embodiment of the invention includes payment options that provide funds necessary to ensure the long term and or perpetual, storage, access and management of any type of content including family/individual DNA data and or scanned personal documents (including Financial and asset information, medical history . . . ) via the family archive are available and accessible for the term agreed and for the adaptation of that content to ensure it can be consumed by future hardware and software. One example of this would be that generations of private family DNA data stored in the family archive could be used to improve the health of future generations.

One embodiment of the invention includes the assignment of a unique code that can be printed anywhere (tombstone, business card, Medical ID . . . ) and when combined with our web site can be used to identify a desired multi-media content stream. For example seeing ‘Gen-Ark-9A4G92BF’ would inform people to go to www.Gen-Ark.com and type in the code 9A4G92BF to view the associated multi-media stream or to use the combination to view a desired stream on viewing device or sync the content of the stream to a device or service.

One embodiment of the invention would allow family members to store information that they would like used (by our service or their defined curator to enhance, delete, archive or otherwise maintain access to or the content on an external web services in the event of their incapacity or demise.

Many embodiments of the invention allow a perpetual SLA to be agreed and used as a means to ensure the sales fee (invested by Legendary Archives to provide a yield that ensures an adequate amount of money is available to support the storage, access and management of content in a generational archive) will be returned if the SLA terms are not consistently met and that the data will also be returned on a type of removable media commonly used at the time.

While the particular embodiments have been illustrated and described, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for perpetually preserving digital content, comprising the steps of:
providing a digital archive for storing the digital content;
making the digital content accessible;
funding the digital archive with a perpetual annuity; and,
granting access to the digital content through the perpetual annuity.

2. The method of claim 1, further comprising the step of providing a trustee function to ensure the digital content and access thereto are maintained.

3. The method of claim 2, wherein the digital content and access thereto are maintained in perpetuity.

4. A method for preserving digital information in perpetuity, comprising the steps of:
providing a digital archive for storing the digital information;
making the digital information accessible to an individual;
funding the digital archive with a perpetual annuity;
granting the individual access to the digital content through the perpetual annuity; and,
providing an independent intermediary to oversee the ongoing accuracy of and access to the digital information.

5. A method for perpetual content preservation comprising:
providing a digital archive for consumers that can be trusted to house and make available in a modern secure format said consumers' digital content;
provided funding for said digital archive is established via one of Legendary Archives Company's unique payment offerings ((i.e. one-time-payment, installment payment, annuity, perpetuity, trust, foundation . . . );
granting guaranteed access for all future generations; and,
providing a trustee function to help ensure that data and access policies specified by the Founder will be executed indefinitely;
providing an independent intermediary between storage service providers, access service providers, elastic computing service providers, Digital Conversion Services and consumers to help ensure families actually receive the service level paid for in perpetuity or for the term agreed by the founder; and
providing a provisioning system that will allow electronic interaction with top financial instrument providers to help ensure accurate fulfillment of services.
